(19) United States
(12) Patent Application Publication
(10) Pub. No.: US 2014/0193014 A1
(43) Pub. Date: Jul. 10, 2014

(54) Speaker Enclosure for Small Form-Factor Devices

(71) Applicant: SILVERPLUS, INC., Irvine, CA (US)

(72) Inventor: Jeffrey Hsieh, Dove Canyon, CA (US)

(73) Assignee: SilverPlus, Inc., Irvine, CA (US)

(21) Appl. No.: 13/735,121

(22) Filed: Jan. 7, 2013

(51) Int. Cl. H04R 1/02

(52) U.S. Cl. CPC H04R 1/02
USPC 381/332; 29/896.23

(57) ABSTRACT

A miniature speaker is describer including a microphone holder and a vibrator holder. A miniature speaker matching the oval shape of a sound chamber is placed face down over the sound chamber. A small slot is formed in one of the sides of the sound chamber to provide a sound portal through which the speaker generated sound is heard. The platform on which the sound chamber is formed also comprises a microphone holder and a vibrator holder. The microphone holder is positioned such that a sound receiving portal of the microphone is orthogonal to the sound portal formed in one of the side walls of the sound chamber.

### RELATED APPLICATIONS

This application is related to the following U.S. Provisional patent applications:
SP12-002, titled “Wearable communication Device and User Interface”, Ser. No. 61/682,804, filing date Aug. 14, 2012,
SP12-004, titled “Wearable communication Device and User Interface”, Ser. No. 61/682,814, filing date Aug. 14, 2012, and
SP12-005, titled “Wearable communication Device/System”, Ser. No. 61/681,792, filing date Aug. 10, 2012,
   all of which are assigned to the same assignee. The contents of these applications are hereby incorporated by reference in their entirety.

### TECHNICAL FIELD

The present disclosure is related to communication devices and in particular to a small communication device where space is a premium such as with a wrist watch size device.

### BACKGROUND

The progress in electronics is directed in one aspect to smaller and smaller devices. When these devices have audio requirements, the speaker system needs to be dimensionally much smaller without sacrificing the quality of audio beyond what is pleasant sounding and that which can be easily understood by a user. In the middle of the last century wrist watch radios came into vogue in some of the popular comic strips, and more recently with creation of wrist watch phone systems. The state of semiconductor levels of integration has been important to getting to the point where a phone can be integrated into a wrist watch size device. Equally, or perhaps more important, is the size of the sound system that must be contained within a wrist watch size device.

US 2012/0122519 A1 (Jochheim) is directed to a wrist phone wherein a speaker is located in the cap and opposite a microphone located in the strap. Opening for the speaker and microphone are covered by a water-impermeable membrane to render the wrist phone water resistant. US 2009/0231960 A1 (Hutcheson) is directed to a wrist watch phone comprising a communication module and uses a headset microphone and receiver activated through BlueTooth. In US 2004/0071308 A1 (Guenther) a low cost broad range loudspeaker is directed for use in portable consumer electronics, wherein the speaker is an electromagnetic speaker with a rare earth magnet with a hole behind the diaphragm to communicate through the speaker. US 2003/0081506 (Karhu) is directed to a radio communications device, a wrist-watch phone, wherein a speaker and a microphone are inside the phone housing below holes for the speaker and a microphone is on opposite sides of the main housing from the speaker.

In U.S. Pat. No. 7,234,010 B2 and U.S. Pat. No. 6,801,476 B2 (Gilmour) a wrist worn phone is directed to a speaker on the back side of the main housing and a microphone located in one of the straps. U.S. Pat. No. 6,311,071 B1 (Voroba et al.) is directed to an apparatus and method for reducing side-tone feedback in wireless portable telephone systems by positioning a microphone and speaker to reduce acoustic feedback. U.S. Pat. No. 5,239,521 (Blonder) is directed to a wristwatch radio telephone wherein a top layer of a wrist band contains a speaker at one end and a microphone at the other end of a strap connected to the wrist band opposite to the wristwatch radio telephone. U.S. Pat. No. 4,847,818 (Olsen) is directed to a wristwatch radio telephone, wherein a wrist strap when opened comprises a speaker at one end of the open wrist strap and a microphone at the other end of the opened wrist strap.

The packaging of a miniature speaker into a small communication device, e.g. a wrist-watch phone, requires an equally miniature speaker enclosure that can be accommodated within the small communication device. Also important is the packaging of the microphone to allow complete communication capability without feedback between the microphone and the speaker.

### SUMMARY

It is an objective of the present disclosure to provide an enclosure for a miniature speaker that can be accommodated in a wrist-watch phone.

It is also an objective of the present disclosure to package the miniature speaker with a microphone on a same platform to be able to provide two way communications with the wrist-watch phone.

It is still an objective of the present disclosure to position the speaker and the microphone in such a way as to minimize, or eliminate, feedback between the speaker and the microphone.

It is yet again an object of the present disclosure to mount the miniature speaker “face down” onto a sound chamber such that sounds from the speaker enters a chamber in a downward direction and exits the chamber in an orthogonal direction from the side of the chamber.

The speaker enclosure is formed from ABS (Acrylonitrile-Butadiene-Styrene) plastic, or a similar smooth and resilient material. The base, or platform, of the speaker enclosure also has enclosures attached for a microphone and a vibrator to provide notification when sound is turned off.

The speaker is preferably an oval shaped, electro-magnetic device that is matched preferably by an oval shaped sound chamber formed on the base platform, which in one exemplary embodiment has dimensions as follows. The sound chamber has a length of approximately 17 mm and a width of approximately 11 mm. The depth of the chamber is approximately 4 mm. At the bottom of the depth of the chamber along one side is an approximate 5 mm wide rectangular portal from the inside the chamber to the outside to allow sound from the speaker out of the chamber. The speaker is placed over the sound chamber face down and forms the speaker enclosure so that sound emanating from the speaker enters directly into the sound chamber. With the inclusion of the microphone holder and the vibrator holder, the base of the platform is approximately 35 mm long.

It should be noted that neither the microphone nor the vibrator need to be included on the same platform as the speaker, and the minimum length of the platform of an exemplary embodiment could be approximately 17 mm without the microphone and the vibrator. The important factor is the orientation of the microphone receiving portal with respect to the speaker chamber output portal, which is substantially orthogonal.

### BRIEF DESCRIPTION OF THE DRAWINGS

This invention will be described with reference to the accompanying drawings, wherein:

FIG. 1A is an isometric diagram of the present disclosure of the sound chamber and includes a microphone enclosure and a vibrator enclosure;

FIG. 1B is an isometric diagram of the present disclosure showing the mating of a speaker with the speaker chamber;

FIG. 2A Is an isometric diagram of the present disclosure showing the speaker platform and chamber from a second orientation; and

FIGS. 2B and 2C are cross section views of the present disclosure demonstrating two possible configurations of the floor of the speaker chamber.

### DETAILED DESCRIPTION

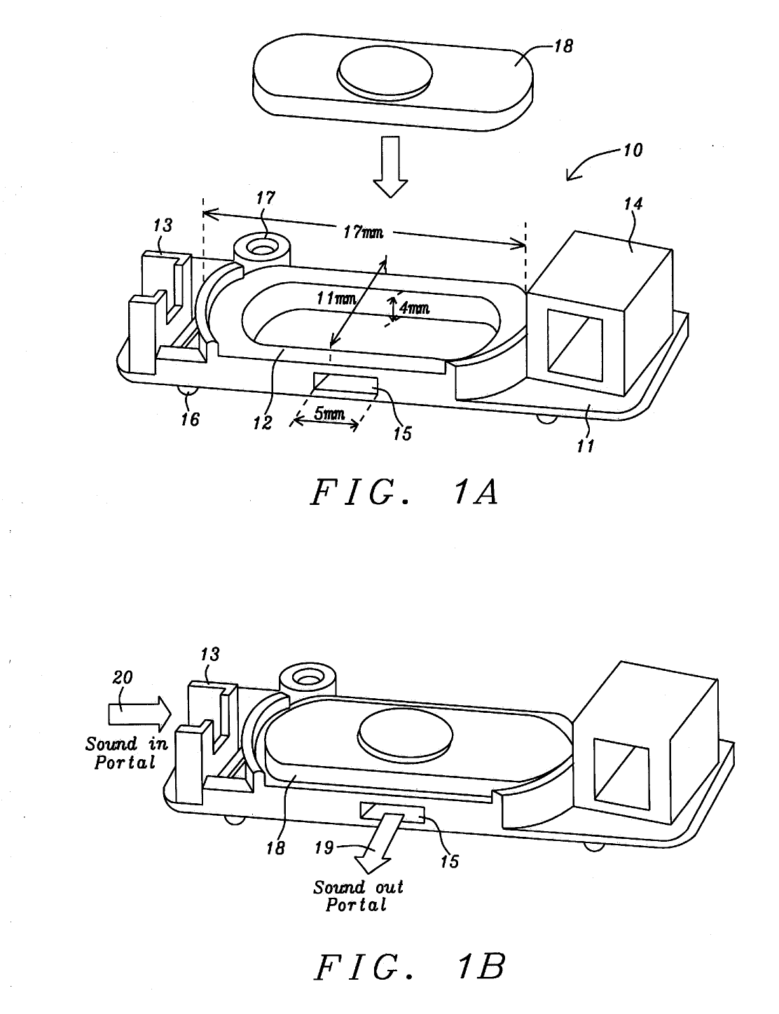

FIG. 1A is an isometric view of the miniature speaker enclosure 10 of the present disclosure comprising a sound chamber 12, a microphone holder 13 and a vibrator holder 14. Dimensions given in this description are for an exemplary embodiment, and may vary for similar speaker enclosures in different applications. The outside dimensions of the sound chamber 12 are, for example, approximately 17 mm×11 mm where the sound chamber is approximately 4 mm deep and has an approximate 5 mm slot 15 low along one of the sides of the sound chamber to create a sound portal and allow sound out of the sound chamber 12. On the platform 11 containing the sound chamber 12 are positioned a microphone holder 13 and a vibrator holder 14. Alignment pegs, or stubs 16 are shown emanating below the platform surface and one of two screw mounting fixtures 17 for attaching the platform to the electronic device, which includes the speaker enclosure 10.

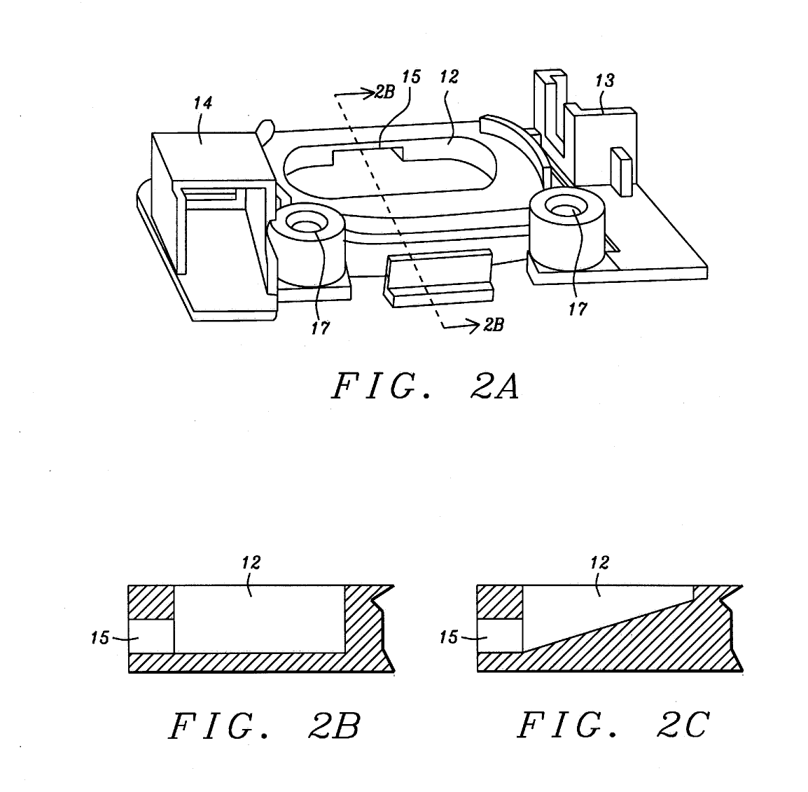

A miniature speaker 18 is shown above the sound chamber 12 in FIG. 2A. The speaker 18 is an oval shape, matches the shape of the sound chamber 12 and is oriented face down looking at the sound chamber. As shown in FIG. 1B the speaker is lowered over the sound chamber and in effect seals the open portion of the sound chamber. The slot in the side of the sound chamber, which extends from the outside into the sound chamber, is the output portal 19 for the sound generated by the speaker. A sound input portal 20 is located at the input to the microphone holder and is orthogonal to the output portal 19.

In FIG. 2A is shown an isometric view of the miniature speaker enclosure from the opposite side shown in FIG. 1A. The two screw mounting fixtures are in clear view and allow the platform comprising the sound chamber 12, the microphone holder 13 and the vibrator holder 14, to be held in position after the alignment pegs 16 are seated into corresponding alignment holes within the electronic device that is using the miniature speaker. FIG. 2B and FIG. 2C show two possible cross section views of the floor of the sound chamber. In the first view, FIG. 2B, is the preferred embodiment of the present disclosure where the floor of the sound chamber is flat and parallel to the upper outer surface of the sound chamber. The second view, FIG. 2C, shows a second embodiment where the floor of the sound chamber is angled downward toward the output sound portal 15.

In one embodiment of the present disclosure, a cover made of a sound-insulating material such as rubber, may be placed over the speaker 18, to prevent unwanted audio output from the top of the speaker back upward into the device in which the disclosed speaker is mounted.

While the invention has been particularly shown and described with reference to preferred embodiments thereof, it will be understood by those skilled in the art that various changes in form and details may be made without departing from the spirit and scope of the invention.

What is claimed is:

1. A miniature speaker enclosure, comprising:
a) a sound chamber formed on a platform from a smooth resilient material;
b) a miniature speaker mounted face down over said sound chamber; and
c) sound exits the sound chamber through a small slot formed in a side wall of the sound chamber

2. The miniature speaker enclosure of claim 1, wherein the sound chamber is an oval shape matched by shape of the miniature speaker.

3. The miniature speaker enclosure of claim 2, wherein the sound chamber is approximately about four millimeters deep with a flat bottom.

4. The miniature speaker enclosure of claim 2, wherein the sound chamber has a sloped bottom that is sloped downward toward the side wall comprising the small slot.

5. The miniature speaker enclosure of claim 1, wherein the smooth resilient material that forms the sound chamber is ABC plastic.

6. The miniature speaker enclosure of claim 1, wherein said platform comprises a microphone holder and a vibrator holder.

7. The miniature speaker enclosure of claim 6, wherein the microphone holder directs sound to a microphone orthogonal to sound output from the sound chamber.

8. A method for creating a miniature speaker enclosure, comprising:
a) forming a platform comprising:
i) a sound chamber;
ii) a microphone enclosure; and
iii) a vibrator enclosure;
b) forming a small slot on a side of the sound chamber to provide an output portal;
c) enclosing said sound chamber by placing a speaker face down over said sound chamber;
d) positioning said microphone enclosure on said platform such that an input portal is orthogonal with said output portal; and
e) installing an assembled miniature speaker enclosure in an electronic communication device having limited space.

9. The method of claim 8, wherein the sound chamber is oval shaped to match a shape of the speaker.

10. The method of claim 9, wherein the sound chamber has a level bottom.

11. The method of claim 9 wherein the sound chamber has a sloped bottom that is sloped downward toward the side wall comprising the small slot

12. The method of claim 9, wherein the sound chamber is approximately four millimeters deep, and the external dimensions are approximately seventeen millimeters long and approximately eleven millimeters wide.

13. The method of claim 8, wherein said small slot is five millimeters wide.
